(19) United States
(12) Patent Application Publication
(10) Pub. No.: US 2026/0365486 A1
(43) Pub. Date: Nov. 19, 2026

(54) ELEVATOR, METHOD FOR INSTALLING ELEVATOR, BUILDING HAVING ELEVATOR, AND METHOD FOR CONSTRUCTING BUILDING

(71) Applicant: HYUNDAI ELEVATOR CO., LTD, Chungcheongbuk-do (KR)

(72) Inventors: Tae Won Lee, Chungcheongbuk-do (KR); Sung Joon Bae, Chungcheongbuk-do (KR); Woo Sung Hwang, Chungcheongbuk-do (KR); Jae Kwang Yu, Chungcheongbuk-do (KR); Dong Hwan Oh, Chungcheongbuk-do (KR); Jung Ho Jung, Chungcheongbuk-do (KR)

(21) Appl. No.: 19/434,635

(22) Filed: Dec. 29, 2025

(30) Foreign Application Priority Data
May 15, 2025 (KR) 10-2025-0063076

(51) Int. Cl. B66B 19/00; B66B 11/00; B66C 13/08

(52) U.S. Cl. CPC B66B 19/00; B66B 11/0005; B66C 13/085

(57) ABSTRACT

According to the present disclosure, a method for constructing a building, may include, when a hoist way is provided in a first portion of a building during building construction, installing a first module in the first portion as an elevator component corresponding to the first portion; and as the building construction continues, when a hoist way is provided in a second portion of the building during the building construction, installing a second module in the second portion as an elevator component. Accordingly, elevators can be constructed quickly.

### CROSS-REFERENCE TO RELATED APPLICATIONS

This application is based on and claims priority under 35 U.S.C. § 119 to Korean Patent Application No. 10-2025-0063076 filed on May 15, 2025, with the Korean Intellectual Property Office, the disclosure of which is incorporated by reference herein in its entirety.

### BACKGROUND

The present disclosure relates to an elevator, a method for installing an elevator, a building having an elevator, and a method for constructing a building.

Technological advancements related to elevators are occurring rapidly. Elevators are advancing in step with the trend toward high-speed operation, high efficiency, eco-friendliness, and smarter operation. One example of this technological advancement is the modular elevator. Unlike conventional elevators, the modular elevators are machine-room-less (MRL) elevators, with their drive, control, and safety systems assembled as individual modules within the hoist way. The modular elevators are manufactured in advance by modularizing components at the elevator factory. They can then be easily assembled on-site. This shortens construction period and is effective in safety management and cost reduction. Other examples include preemptive fault detection and smart control technologies utilizing artificial intelligence (Al) and/or the Internet of Things (IoT). Furthermore, attempts are being made to expand the technology into future means of transportation, such as urban air mobility (UAM), which the applicant is researching. Thus, elevators are expanding beyond their mere means of transportation within buildings, and are undergoing various technological expansions.

An example of the technology for the modular elevator is Application No. 10-2024-199353, filed by the applicant herein, entitled “Entrance Module, Modular Elevator Including Entrance Module, and Method for Assembling Entrance Module.” This technology introduces a technology for precision assembly of the platform module. Another technology is Application No. 10-2024-0081110, filed by the applicant herein, entitled “Method for Manufacturing a Modular Elevator.” This technology introduces a technology for precision assembly of the rails.

Despite being installed within a building, the elevators are often treated as a separate process from the building itself. Consequently, numerous inconsistencies arise on-site.

### SUMMARY

The prior art has the following technical challenges.

First, because elevator installation is only possible after the framework is completed, parallel process is impossible, the overall construction period is delayed. Specifically, conventional elevator installation methods require securing space within the hoist way after the building framework is completed. Furthermore, due to the enclosed hoist way, it is difficult to introduce components from outside. Furthermore, because components must be assembled manually within the hoist way, elevator installation and the building framework cannot proceed in parallel.

Second, the on-site manual assembly of elevator components can lead to variations in construction quality and increased safety accidents. Specifically, all elevator components (for example, rails, doors, and toe guards) must be assembled separately at the construction site. Therefore, elevator quality depends on the skill of the workers. Furthermore, working in high-rise hoist ways is often confined and hazardous. For example, there are problems such as fallen object accidents and musculoskeletal fatigue accumulation.

Third, the inability to apply vertical introduction methods using external equipment such as cranes and lifts leads to low construction efficiency. Specifically, traditional hoist way designs, which do not consider the building's open top structure, rely on traditional methods such as horizontal introduction or internal lifting. However, these traditional methods increase equipment use inefficiencies and risks in high-rise buildings.

Hereinafter, solutions to the technical problems will be described. The first problem of the [technical problem] can be solved by enabling elevator installation in parallel with the building framework process. Additionally, a structure can be provided that ensures installation efficiency without interference between the building construction process and the elevator installation process. The second problem of the [technical problem] can be solved by pre-assembling elevator components at the factory, minimizing on-site work. The third problem of the [technical problem] can be solved by utilizing the opening at the upper portion of the hoist way to enable vertical introduction using an external crane. Furthermore, a structure that enables rapid and stable installation even in high-rise buildings can be provided.

The solution to the technical problem is described in more detail.

According to the present disclosure, a method for constructing a building, may include, when a hoist way is provided in a first portion of a building during building construction, installing a first module in the first portion as an elevator component corresponding to the first portion; and as the building construction continues, when a hoist way is provided in a second portion of the building during the building construction, installing a second module in the second portion as an elevator component. Accordingly, elevators can be constructed quickly.

The second portion of the building may be at a higher position than the first portion of the building.

The installation of the first module and the installation of the second module disposed above the first module may be repeated until at least three modules are stacked and the installation of the elevator is completed.

The second module may be fastened to the wall of the hoist way or the first module.

At least one of the at least three modules may include a hexahedron provided by connecting bars having a predetermined cross-section.

A ceiling may be provided on an upper portion of an upper end module, which is disposed at the highest position among the at least three modules, to prevent falling objects.

The at least three modules may include a lower end module disposed at the lowest position among the at least three modules, an upper end module disposed at the highest position among the at least three modules, and at least one intermediate module provided between the lower end module and the upper end module.

The method for constructing a building may further include an adapter module provided on at least one of the upper and lower portions of the intermediate module.

A winch may be disposed on the upper end module, and the winch may lift elevator components excluding at least three modules to install the elevator.

After installation of the elevator, the winch may be removed.

The upper end module may extend in the horizontal direction and include at least one horizontal bar capable of being expanded in the horizontal direction, and a hole into which the horizontal bar is inserted may be provided in the wall of the hoist way.

At least one of the at least three modules may be introduced through an upper surface opening of the building that is connected with the hoist way in the vertical direction.

At least one of the at least three modules can be introduced into the hoist way by the operation of a crane.

According to the present disclosure, a method for installing an elevator may include assembling a first module and a second module as components of an elevator providing the elevator at a production site of the elevator; constructing a first portion of a hoist way, in which the first module is installed, at a construction site according to building construction; installing the first module, transported to the construction site, in the first portion of the hoist way; constructing a second portion of a hoist way, in which the second module is to be installed, above the first portion of the hoist way according to building construction; and installing the second module, transported to the construction site, in the second portion of the hoist way.

The second module may be fastened to at least one of the first module and the wall of the hoist way.

The first module and the second module may be introduced through an upper surface opening of the building that is connected with the hoist way in the vertical direction.

At least one of the first module and the second module can be introduced into the hoist way by the operation of a crane.

The operation of the crane may include an operation of hoisting and lifting the at least one module, an operation of aligning the at least one module with an opening of the hoist way in the vertical direction, an operation of hoisting and lowering the at least one module within the hoist way, and an operation of fixing and removing the at least one module from the hoist way.

The second module may include a ceiling that prevents damage from falling objects; a guide part that guides the falling objects; and a discharge hole that guides the falling objects to a platform.

At least one of the first module and the second module may provide a frame having a predetermined cross-section. The frame may include a horizontal bar, a vertical bar, and a reinforcing bar for supporting the horizontal bar.

The present disclosure may have the following effects.

First, by performing the building framework construction and elevator installation processes in parallel, the building construction period can be shortened. Second, by pre-assembling elevator components at the factory, on-site work can be minimized, installation quality can be uniform, and work safety can be improved. Third, the open structure above the hoist way and the crane introduction method through it allow for safe and rapid elevator installation, even in high-rise buildings.

In addition, the detailed description of the present disclosure may further add to effects thereof.

### BRIEF DESCRIPTION OF THE DRAWINGS

FIGS. 1(a) and 1(b) are structural diagrams illustrating a building and an elevator, where FIG. 1(a) illustrates an elevator provided in a building, and FIG. 1(b) illustrates an elevator in which elevator modules are stacked.

FIGS. 2(a) and 2(b) are time tables illustrating a method for constructing a building of the present disclosure compared to the prior art, where FIG. 2(a) is the prior art and FIG. 2(b) illustrates a method for constructing a building of the present disclosure.

FIG. 3 is a diagram illustrating the time-series change in the introduction of modules through the opening at the upper end of the hoist way.

FIG. 4(a)-4(c) are drawings explaining a structure in which an upper end module is supported on a hoist way, where FIG. 4(a) is a perspective view, FIG. 4(b) is a side view of a horizontal bar of the upper end module, and FIG. 4(c) is a cross-sectional view of a horizontal bar of the upper end module.

FIG. 5 is a perspective view illustrating the upper structure of an elevator including an upper end module.

FIG. 6 is a perspective view illustrating the upper end module further including the ceiling part.

FIG. 7 is a flowchart explaining a method for constructing a building.

### DETAILED DESCRIPTION OF THE EMBODIMENTS

Hereinafter, specific embodiments of the present disclosure will be described in detail with reference to the drawings. The idea of the present disclosure is not limited to the following embodiments. Those skilled in the art who understand the idea of the present disclosure can easily propose other embodiments within the same idea by adding, modifying, deleting, or adding elements. However, this also falls within the idea scope of the present disclosure.

The present disclosure may include a plurality of embodiments. A first element of a first embodiment among the plurality of embodiments may be included by adding or modifying elements of another embodiment. A first element of a first embodiment among the plurality of embodiments and a second element of a second embodiment among the plurality of embodiments may be combined to provide another embodiment not specified in the plurality of embodiments.

In the description of the drawings, regardless of the drawing number and symbol, identical or similar elements are given identical or similar reference numbers, and redundant descriptions thereof may be omitted.

The drawings are provided solely to facilitate understanding of embodiments of the present disclosure, and the technical ideas of the present disclosure are not limited by the attached drawings. It should be understood that all modifications, equivalents, or alternatives included within the idea and technical scope of the present disclosure are included.

In describing the embodiments of the present disclosure, a detailed description of a related known technology may be omitted if it is determined that the detailed description may obscure the gist of the embodiments disclosed in the present specification.

In describing embodiments of the present disclosure, specific examples of related known technologies may be included in the specification. In this case, the technical connection between the known technologies and the present disclosure may be included within the technical idea of the present disclosure.

In the present disclosure, terms including ordinal numbers, such as “first,” “second,” or the like, may be used to describe various elements, but the elements are not limited by the terms. The terms may be used to distinguish one element from other element.

When an element is referred to as being “connected” or “accessed” to another element, it should be understood that it may be directly connected or accessed to other element, but that there may be other elements in between. Conversely, when an element is referred to as being “directly connected” or “directly accessed” to another element, it should be understood that there are no other elements in between.

A singular expression may include a plural expression unless the context clearly indicates otherwise.

In the present disclosure, terms such as “comprises” or “has” are intended to indicate the presence of a feature, number, step, operation, element, component, or combination thereof described in the specification. Therefore, they do not exclude the possibility of the presence or addition of one or more other features, numbers, steps, operations, elements, components, or combinations thereof.

In the present disclosure, the term “module” may mean a frame structure that is installed within a hoist way and to which elevator components such as elevator rails, door modules, buffers, and traction machines are pre-fastened. In addition, “the installation of the elevator is complete” may mean that the elevator is installed within the hoist way and the traction machine installation and roping are completed, thereby making the elevator operable.

In the present disclosure, if the direction is indicated, a direction of gravity can be defined as a vertical direction. A direction perpendicular to the direction of gravity can be defined as a left and right direction. A direction perpendicular to both the vertical and left and right directions can be defined as the front and rear direction. The front and rear direction can be exemplified by the direction viewed by an observer.

### Example 1

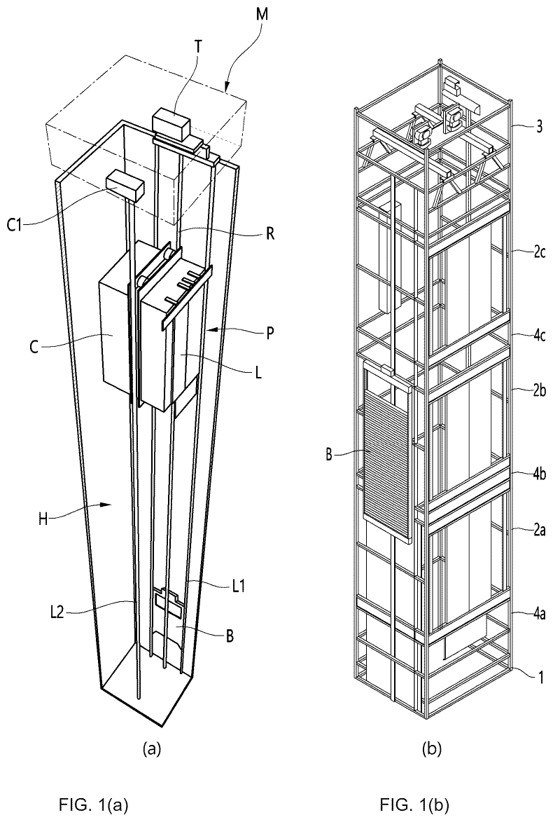

FIGS. 1(a) and 1(b) are structural diagrams illustrating a building and an elevator, where FIG. 1(a) illustrates an elevator provided in a building, and FIG. 1(b) illustrates an elevator in which elevator modules are stacked. See FIGS. 1(a) and 1(b).

### [Configuration and Operation of Elevator]

An elevator can be installed in a building. Here, the building can be exemplified by a reinforced concrete structure, a steel structure, and a modular structure. The building can provide a platform and a hoist way to install the elevator. The platform and the hoist way can form a component of the elevator. The platform P can be exemplified by an entrance/exit space of each floor where the car C stops. A plurality of platforms can be provided in the building. The hoist way H can be exemplified by a passage through which the car C is raised and lowered. Components such as a traction machine T and a control module C1 that raise and lower the car C can be disposed on the upper end of the hoist way.

A door module L may be provided on the platform. The door module can be opened and closed in conjunction with the door of the car C. The traction machine T can rotate the rope R in both directions. The rope R can be wound around a sheave provided on the output side of the traction machine T. The rope R can extend in both directions with the traction machine as the geometric center. In other words, the rope R is supported by the sheave, and both ends thereof can extend downward by gravity.

The car C may be supported on the first side where the rope extends in one direction. A counterweight B (balance weight) may be supported on the second side where the rope extends in the other direction. The counterweight may compensate for the weight of the car C and the load loaded on the car. The counterweight may reduce energy consumption of the elevator, smoothen the operation of the elevator, and increase the stability of the system. Various methods for connecting the rope R, the car C, and the counterweight B may be provided according to the specifications, use, allowable load, and standards of the building and the elevator. Various methods for connecting the rope R, the car C, and the counterweight B may be included in the idea of the present disclosure.

According to the control of the control module C1, the traction machine T can be selectively driven. By moving the rope R wound around the sheave, the car C can move in the hoist way H in the vertical direction. By moving the rope R wound around the sheave, the car C and the counterweight B can move in the vertical direction. At this time, the car C and the counterweight B can move in opposite directions to each other. The vertical movement of the car C and the counterweight B can be guided by the first rail L1 and the second rail L2.

According to the control of the control module C1, the car C can stop at a specific location. The car C can stop corresponding to a specific platform P. The door of the car C and the door module L of the specific platform can be opened together.

Additional portions may be required for the configuration and operation of the elevator. For example, the counterweight B may also be provided with a sheave around which the rope R is wound. Even if each portion is not described in the present disclosure, the applicant declares that the portions necessary for the configuration and operation of the elevator are included in the present disclosure.

### [Configuration and Operation of Rails L1 and L2]

The rails L1 and L2 can be installed to extend vertically from the inner surface of the hoist way H. The rails L and L2 can be fastened to the inner surface of the hoist way H. The rails L and L2 can be directly fastened to the inner surface of the hoist way H using a single type of fastener or indirectly fastened using two or more types of fasteners. The rails Land L2 can guide the vertical movement of the car C and the counterweight B. The rails can prevent the car C and the counterweight B from swinging in the left and right direction and in the front and rear direction. The rails can have a plurality of sub-components connected vertically. The sub-components can refer to sub-components that form a component of the elevator. For example, a rail part of a predetermined length that provides a component as a single rail that is a component of the elevator can be referred to as a sub-component with respect to the single rail. The same applies hereinafter.

If the alignment of the sub-components is misaligned, problems such as vibration may occur during elevator operation. Furthermore, once the rail is fixed, it is difficult to adjust the alignment of the rail even if an error in the alignment of the rail is confirmed due to the amplified joint tolerance between a plurality of sub-components. As a technology to resolve this, the applicant's prior art application No. 10-2024-0081110, entitled “Method for Manufacturing a Modular Elevator,” discloses a fish plate, a clip member, and a fixing block for aligning. Precisely fixing the rail to the reference position can be said to be one of the core technologies in the field of elevator technology.

### [Elevator Module]

The modules of the elevator can be classified according to the height at which the modules are stacked in the hoist way. For example, the modules can include a lower end module 1 at the lowest floor. An intermediate module 2 can be stacked on top of the lower end module corresponding to each platform. The door module L can be installed corresponding to the intermediate module. At least two 2a, 2b, and 2c of the intermediate modules can be provided. An adapter module 4 that directly contacts the intermediate module can be provided on at least one of the upper end and the lower end of one of the intermediate modules. The adapter module 4 can be provided to adjust the vertical spacing between each module according to the specifications of the building. At least two 4a, 4b, and 4c of the adapter modules 4 can be provided as needed. An upper end module 3 can be stacked on the upper side of the highest intermediate module among the at least two intermediate modules.

The module may be provided by fastening bars having predetermined cross-sections extending in the vertical direction, in the front and rear direction, and in the left and right direction. The module may be provided as a hexahedral frame in which a plurality of the bars are connected. The cross-section of the bar may have at least one bent part. The cross-section of the bar may be provided as a square. The cross-section of the bar may be provided as a hollow square. The cross-section of the bar may be provided as a hollow square with one edge removed. The cross-section of the bar may be provided as a hollow square with two consecutive edges removed. The module including the bars may be fastened to the building or another adjacent module. Components of the elevator may be fixed and assembled to the frame. For example, rails, doors, buffers, or the like may be pre-assembled to the frame at the elevator production site.

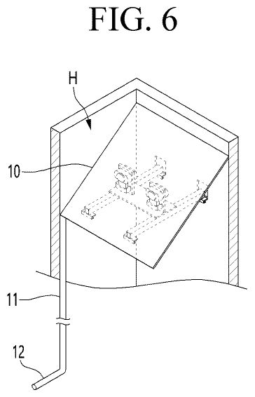

Any one of the intermediate modules may be provided corresponding to any one of the platforms. In other words, one door module L may correspond to one intermediate module that is stacked. Of course, according to the specifications of the modules, one or more door modules may correspond to one intermediate module, or one or more intermediate modules may correspond to one door module. This may correspond to various specifications of the building. A pit module may be provided in the lower end module 1. The pit module may be disposed at the lowest end portion of the elevator, and a buffer and a sensor may be installed therein. The pit module may be directly disposed on the foundation structure during the construction of the building. A machine room module may be provided in the upper end module 3. The machine room module may provide a space for supporting a driving device. The traction machine T, the winch T1, electrical wiring, and control equipment may be supported therein. The upper end module 3 may be provided in two layers. A winch and a work plate may be provided on the lower layer of the two layers. A ceiling (see 10 in FIG. 6) may be provided on an upper end of the upper layer of the two layers.

As a module of the elevator, a shaft module may be provided. The shaft module may provide a guide for a car to safely raise and lower by contacting the shaft module. The shaft module may include the rail and electrical wiring. At least one of the shaft module and the door module may be pre-fastened to the intermediate module. Here, the meaning of “pre-fastened” may mean that the module is fastened to the frame providing the module and moves together during movement.

As a module of the elevator, the control module C1 may be provided. In a narrow sense, the control module may refer to a control panel disposed in the machine room. In a broad sense, the control module C1 may include components such as a control panel, a communication device, an emergency backup power source, a remote monitoring system, a power line, a control line, and a safety circuit. The control module may also be disposed in other areas of the building other than the hoist way and the platform.

### [Installation of Elevator Modules]

The elevator modules can be installed during the construction of a building, or concurrently with the construction of the building. For example, the building construction may include foundation work to solidify the ground, framework construction to build the frame of a building, and finishing construction which finishes the interior and exterior of the framework. In the present disclosure, each module of the elevator can be installed concurrently with the framework construction. The stacked elevator modules can provide an operable elevator.

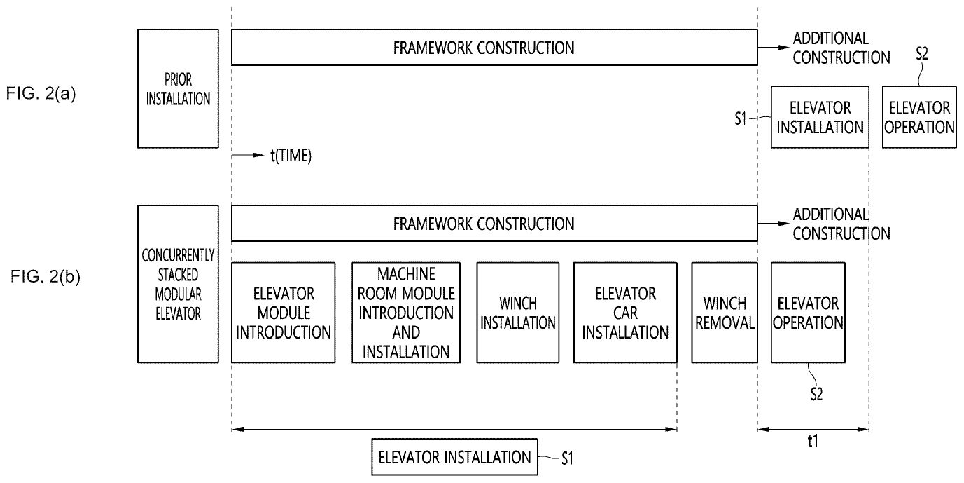

FIGS. 2(a) and 2(b) are time tables illustrating a method for constructing a building of the present disclosure compared to the prior art, where FIG. 2(a) is the prior art and FIG. 2(b) illustrates a method for constructing a building of the present disclosure. See FIGS. 2(a) and 2(b).

Building construction can be performed in a time series manner (progressing in the direction of t). According to the prior art, after the framework construction is completed, an elevator installation (S1) can be performed as a process of the additional construction. The elevator installation (S1) can take a long time. Therefore, it can take a long time until the elevator operation (S2). Due to the delay in the elevator operation (S2), the additional construction can be delayed and the construction cost can increase. For example, since it is inconvenient to move to each platform P at different heights, the additional construction takes more time and cost.

According to the present disclosure, the elevator installation (S1) can be performed together with the framework construction. During the framework construction, the hoist way can be provided in an open state. The open state of the hoist way can include an open upper end of the hoist way. The hoist way can be blocked in the front and rear direction and left and right direction. Of course, the platform and the hoist way can be connected to each other. The hoist way can be disposed inside a building. The hoist way can extend in a vertical direction while being blocked at the lower end thereof. The uppermost end of the hoist way can be open to an external space to provide an opening. Through the opening, components of the elevator and modules of the elevator can be lifted (including hoisting and lifting by a crane).

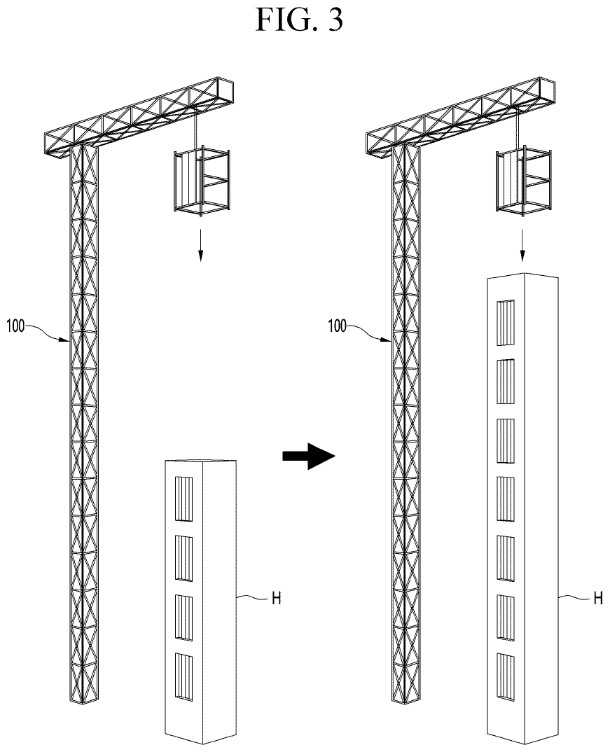

FIG. 3 illustrates the opening and the operation through the opening. Refer to FIG. 3. A crane 100 capable of lifting a module of the elevator having a predetermined weight is prepared. The crane can lift the module 1, 2, and 3 of the elevator and introduce the module into the hoist way (including hoisting and lifting by the crane). Specifically, the operation of the crane can perform an operation of hoisting and lifting the module of the elevator by hanging it, an operation of aligning the module of the elevator with the opening of the hoist way in the vertical direction, an operation of hoisting and lowering the module of the elevator inside the hoist way, and an operation of fixing and removing the module of the elevator from the hoist way (which may include detaching the hook).

The operation of the crane may be repeatedly performed as the height of the hoist way increases. In FIG. 3, the arrows are a diagram illustrating the relationship between the repeated operation of the crane and the height of the building in time series. Accordingly, the modules of the elevator may be stacked according to each height. For example, when the framework construction of a building providing a platform corresponding to an intermediate module of a first height is completed, the intermediate module of the first height may be installed. Thereafter, when the framework construction of a building providing a platform corresponding to a module of a second height (for example, an intermediate module) is completed, the module of the second height may be installed. Here, the second height may be higher than the first height. Consequently, the modules of the elevator may be installed according to the height at which the framework construction is performed. The operation of the crane may be repeated until all modules that are components of the elevator are stacked.

Referring again to FIG. 2(a) and 2(b), the elevator installation (S1) will be described in detail. The modules 1, 2, 3, and 4 of the elevator can be installed sequentially. The drawing illustrates that the process proceeds in time series: first, installation of an elevator module (for example, an intermediate module 2); second, introduction and installation of a machine room module (for example, an upper end module 3); third, installation of a winch; fourth, installation of a car C; and fifth, removal of a winch.

First, the installation of the module of the elevator may include the lower end module 1. If the lower end module is performed integrally with the framework construction, the installation may begin with the intermediate module. For example, the pit module may be integrated with the framework during the framework construction. The first step may be repeatedly performed according to the height of the framework construction. Second, the introduction and installation of the machine room module may include the introduction and installation of the upper end module of the elevator. At this time, a traction machine and a winch may be provided together in the machine room. Third, the installation of the winch may include installing a rope to the winch. The winch may perform the lifting of components required for the installation of the elevator. The winch may be distinct from the traction machine and may be a lifter which is temporarily used. Fourth, the installation of the car C may include introducing and installing a plurality of components that provide the elevator into the hoist way. The installation of the car may include winding a rope around the traction machine. Fifth, the removal of the winch may include removing a winch that has been retired from use. After this, elevator operation (S2) may be possible.

In the hoist way, the frames of each module of the elevator can be sequentially stacked from the lower portion. To ensure alignment and fixation between the frames during the stacking process, the frames can be provided with an interconnection structure or fixing part between the frames. As another example, the frames can be fastened to the inner surface (or wall surface) of the hoist way. One frame can be fastened to at least one of the inner surface of the hoist way and another adjacent frame.

Comparing the prior art (a) with the present disclosure (b), it can be seen that a significant time difference t1 occurs between the construction of the building and the elevator operation (S2). Accordingly, the effects of the present disclosure can be clearly understood.

### [Presence of Machine Room and Relationship Thereof to the Present Disclosure]

The present example exemplifies an elevator of the machineless type without a machine room M. However, the idea of the present disclosure is not inapplicable to a building having a machine room. For example, the machine room M may be provided at the upper end of the hoist way. Components such as a traction machine T and a control module C1 for raising and lowering the car C may be disposed in the machine room M. When the machine room is provided, a frame for a portion of the upper end module may be provided. When the machine room is provided, the upper end module 3 may not be provided separately. The machine room M may be provided as a step in the building construction after the intermediate module is provided. Thereafter, the traction machine T and the control module C1 may be installed inside the machine room. However, the idea of the present disclosure may be more suitable for the machineless type elevator.

### Example 2

The present example discloses the configuration of the upper end module. The present example discloses the configuration of an elevator module corresponding to the elevator module being introduced through an opening on the upper surface of a building. Portions similar to those of the first example will be omitted, and other portions will be described with emphasis.

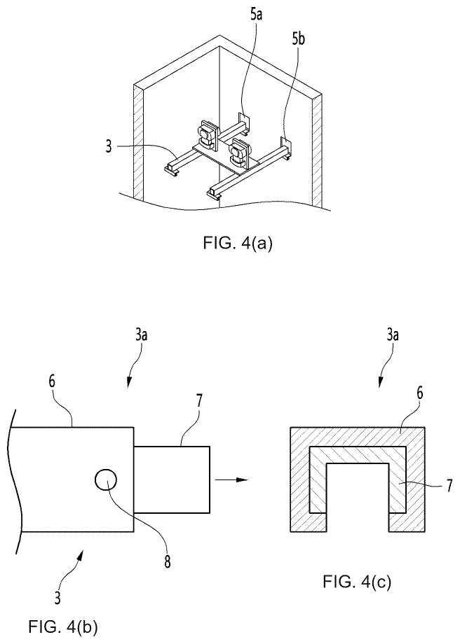

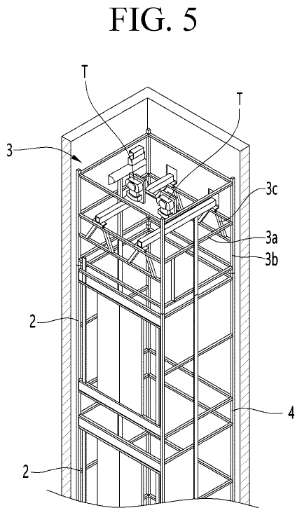

FIG. 4(a)-4(c) are drawings explaining a structure in which an upper end module is supported on a hoist way, where FIG. 4(a) is a perspective view, FIG. 4(b) is a side view of a horizontal bar of the upper end module, and FIG. 4(c) is a cross-sectional view of a horizontal bar of the upper end module. FIG. 5 is a perspective view illustrating the upper structure of an elevator including an upper end module. FIG. 6 is a perspective view illustrating the upper end module further including the ceiling part.

The intermediate module 2 and the adapter module 4 (optional) can be stacked in the vertical direction. The upper end module 3 can be provided at the upper end of the hoist way. The upper end module 3 can include a vertical bar 3b extending in the vertical direction and a horizontal bar 3a extending in the front and rear direction and in the left and right direction. In order to increase the strength of the bars 3a and 3b, a reinforcing bar 3c extending in an inclined direction can be provided. The reinforcing bar can be provided to be inclined obliquely with respect to any one of the vertical direction/front and rear direction/left and right direction. Here, the inclination angle can be less than 90 degrees and greater than 0 degrees. The inclination angle can be in the range of 40-50 degrees. The reinforcing bar 3c can have at least two reinforcing parts, one end of which can be in contact with each other, and the other end can be spaced apart from each other. Here, the contact can include direct contact or indirect contact. Here, one end of the at least two reinforcing parts can support the same bar together. Here, the other ends of the at least two reinforcing parts can support different bars.

A traction machine T can be disposed on the bars 3a, 3b, 3c. A winch T1 can be disposed on the bars 3a, 3b, 3c. The traction machine and the winch can be disposed on the horizontal bar 3a. The horizontal bar 3a on which the traction machine or the winch is disposed can have higher strength than other bars. The horizontal bar on which the traction machine and the winch are disposed can be supported by the reinforcing bar.

The horizontal bar 3a may be provided as an elastic bar. The horizontal bar 3a may be provided in a structure in which two bars overlap in the longitudinal direction. Referring mainly to FIG. 4(b). The horizontal bar 3a is provided in a configuration in which at least two bars 6 and 7 overlap in the longitudinal direction. One of the bars included in the horizontal bar may be withdrawn or introduced in from the other. The bars of the horizontal bar may freely move relative to each other in the longitudinal direction (for example, the front and rear direction). In contrast, the bars of the horizontal bar may not move relative to each other in the width direction (for example, the left and right direction) or the bending direction (for example, the vertical direction). The horizontal bar 3a may reach a predetermined length by withdrawing at least two bars 6, 7.

The both end portions of the horizontal bar may be fixed to opposite surfaces of the hoist way. The horizontal bar may be inserted into the hoist way in a shortened state in length. Thereafter, after the horizontal bar has been extended in length, both ends of the horizontal bar may be fixed to opposite surfaces of the hoist way. Here, the fixing may include insertion or fitting.

Both end portions of the horizontal bar can be inserted into holes 5a and 5b on the inner surface of the hoist way H. Here, the holes may be in the form of pocket holes or concave recesses. In the drawing, one end portion of two different horizontal bars can be inserted into two holes 5a, 5b. When the horizontal bar 3a is fixed to the holes 5a and 5b, the lengths of the two bars 6, 7 providing the horizontal bar can be fixed. In order to fix the lengths of the two bars, a connecting hole 8 connecting the two bars 6, 7 can be provided. A fastening member such as a bolt can be inserted into the connecting hole 8. The fastening member can fasten the two bars together. The fastening member can prevent the length of the horizontal bar from changing.

When the upper end module 3 is fastened to the hoist way, the upper portion of the hoist way remains open until the building is finished. In other words, the opening remains open until the building is finished. Rainwater and foreign substances may fall through the opening. To prevent this, a ceiling 10 may be installed on the upper portion of the upper end module. For example, the ceiling 10 may prevent damage to workers and elevator components due to fallen objects during construction, and deterioration of elevator components due to rainwater and foreign substances. A guide part 11 for guiding (inducing) the fallen object may be provided on one side of the ceiling. When the fallen object is rainwater, the guide part may be a drain pipe. A discharge hole 12 for guiding the fallen object to the platform may be provided at the lower end of the guide part. The discharge hole may be closed during the finishing construction.

The ceiling 10 and the structure 11, 12 for discharging fallen objects from the ceiling may also be provided for the intermediate module. For example, after one of the intermediate modules is installed, a predetermined period of time may elapse during the building construction step. In this case, damage due to foreign substances, similar to the upper end module, may occur to the intermediate module. Accordingly, the ceiling may also be installed for the intermediate module. If another module is stacked above the intermediate module, the ceiling may be removed. The ceiling 10 and the structure 11, 12 for discharging fallen objects from the ceiling may also be provided for the lower end module 1.

The ceiling 10 and the structure 11, 12 for discharging fallen objects from the ceiling can be removed after the elevator installation is completed. The completion of the elevator installation may include blocking the opening on the upper surface of the building, that is, the upper end opening of the hoist way.

### Example 3

The present example details a method for constructing a building. Here, the method for constructing a building also includes a method for installing an elevator as a portion of the building.

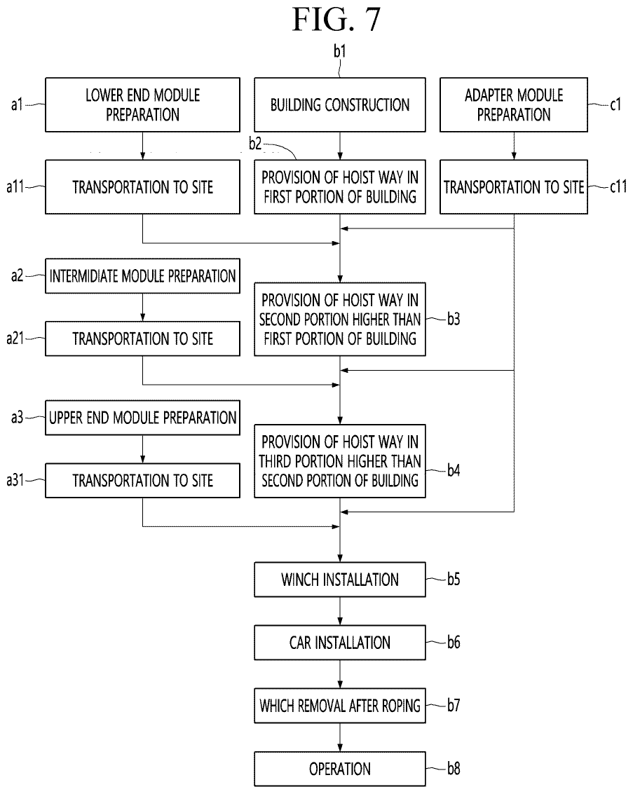

FIG. 7 is a flowchart explaining a method for constructing a building. See FIG. 7.

Building construction and elevator module production can be performed at different sites. Here, the elevator module may include at least one of a lower end module, an intermediate module, and an upper end module. The lower end module, intermediate module, and upper end module may each have a frame (a hexahedron provided with a plurality bars) prepared independently. The frame may have components, including at least one of a rail, a door, a toe guard, and a buffer, fastened to the frame. The fastening of the components may be provided at the elevator manufacturing site. The frame may be the minimum unit for on-site transport and installation of the elevator. The frame may be provided for each platform. By performing the process, at least one of lower end module preparation (a1), intermediate module preparation (a2), and upper end module preparation (a3) may be performed. Optionally, adapter module preparation (c1) may be performed. The adapter module preparation (c1) may be performed only when necessary. The present disclosure may include manufacturing of any one module at any one elevator manufacturing site. In other words, manufacturing may also include manufacturing at different elevator manufacturing sites, as needed.

The modules prepared through the lower end module preparation (a1), intermediate module preparation (a2), upper end module preparation (a3), and adapter module preparation (c1) can be transported to the site (a11), (a21), (a31), (c11) when necessary. The transportation of each of the modules (including the frame) to the construction site can be carried out in parallel with the framework construction. For example, the corresponding module can be pre-introduced to the construction site when the framework construction in which corresponding module is to be installed is being performed. Accordingly, the required module can be reflected in a timely manner. Accordingly, the construction site can be uncomplicated. Each module at the elevator manufacturing site can be managed with a low inventory rate. Accordingly, the production management of elevator components can be facilitated.

Separately from the module preparation, building construction may be performed (b1). During the building construction, a hoist way may be provided in the first portion of the building (b2). The lower end module corresponding to the first portion may be installed in the first portion. The adapter module may then be installed. According to the case (where there is no lower end module or where the adapter module is not required), elevator components may be constructed in the first portion together with the building construction. The installation of the lower end module in the first portion may be performed through an upper opening in the building, as previously described. The same applies hereinafter.

As the building construction continues, a hoist way may be provided in a second portion of the building during the building construction (b3). The second portion of the building may be at a higher position than the first portion of the building. The intermediate module corresponding to the second portion may be installed in the second portion. The adapter module may be installed before the intermediate module is installed in the second portion. Alternatively, the adapter module may be installed after the intermediate module is installed in the second portion. The adapter module may not be installed. The installation sequence of the intermediate module may be repeated. The number of repetitions of the installation sequence of the intermediate module may depend on the number of the platforms.

As the building construction continues, after the installation of the intermediate module is completed, the upper end module can be installed. During the building construction, a hoist way can be provided in a third portion of the building (b4). The upper end module corresponding to the third portion can be installed in the third portion. The third portion of the building can be at a higher position than the second portion of the building. The third portion of the building can be the highest portion of the hoist way. The adapter module can be installed before the upper end module is installed in the third portion. Alternatively, the adapter module can be installed after the upper end module is installed in the third portion. The adapter module may not be installed.

Afterwards, the winch T1 installed on the upper end module can be movably installed (b5). For example, a rope can be hung on the movable part of the winch to raise and lower components required for elevator installation. Here, the components may include the car C. The car can then be installed (b6). Here, the car is an example, and components required for the operation of the elevator can be installed by the winch. The winch is not essential for the installation of the components. For example, use of a hydraulic device or an introduction from the platform can be used. The elevator installation can be completed through the process.

Afterwards, the winch T1 can be removed by roping the traction machine T (b7). Afterwards, the elevator operation (S2) can be performed normally.

### INDUSTRIAL APPLICABILITY

The present disclosure may provide various advantages to elevators and buildings having such elevators.

What is claimed is:

1. A method for constructing a building, comprising:
when a hoist way is provided in a first portion of a building during building construction, installing a first module in the first portion as an elevator component corresponding to the first portion; and
as the building construction continues, when a hoist way is provided in a second portion of the building during the building construction, installing a second module in the second portion as an elevator component,
wherein the second portion of the building is at a higher position than the first portion of the building, and
wherein the installation of the first module and the installation of the second module disposed above the first module are repeated until at least three modules are stacked and the installation of the elevator is completed.

2. The method for constructing a building of claim 1, wherein the second module is fastened to the wall of the hoist way or the first module.

3. The method for constructing a building of claim 1, wherein at least one of the at least three modules includes a hexahedron provided by connecting bars having a predetermined cross-section.

4. The method for constructing a building of claim 1, wherein a ceiling is provided on an upper portion of an upper end module, which is disposed at the highest position among the at least three modules, to prevent fallen objects.

5. The method for constructing a building of claim 1, wherein
the at least three modules include a lower end module disposed at the lowest position among the at least three modules,
an upper end module disposed at the highest position among the at least three modules, and
at least one intermediate module provided between the lower end module and the upper end module.

6. The method for constructing a building of claim 5, further comprising:
an adapter module provided on at least one of the upper and lower portions of the intermediate module.

7. The method for constructing a building of claim 5,
wherein a winch is disposed on the upper end module, and
wherein the winch lifts elevator components excluding at least three modules to install the elevator.

8. The method for constructing a building of claim 7, wherein after installation of the elevator, the winch is removed.

9. The method for constructing a building of claim 5,
wherein the upper end module extends in the horizontal direction and includes at least one horizontal bar capable of being expanded in the horizontal direction, and
wherein a hole into which the horizontal bar is inserted is provided in the wall of the hoist way.

10. The method for constructing a building of claim 1, wherein at least one of the at least three modules is introduced through an upper surface opening of the building that is connected with the hoist way in the vertical direction.

11. The method for constructing a building of claim 10, wherein at least one of the at least three modules can be introduced into the hoist way by the operation of a crane.

12. A method for installing an elevator comprising:
assembling a first module and a second module as components of an elevator providing the elevator at a production site of the elevator;
constructing a first portion of a hoist way, in which the first module is installed, at a construction site according to building construction;
installing the first module, transported to the construction site, in the first portion of the hoist way;
constructing a second portion of a hoist way, in which the second module is to be installed, above the first portion of the hoist way according to building construction; and
installing the second module, transported to the construction site, in the second portion of the hoist way.

13. The method for installing an elevator of claim 12, wherein the second module is fastened to at least one of the first module and the wall of the hoist way.

14. The method for installing an elevator of claim 12, wherein the first module and the second module are introduced through an upper surface opening of the building that is connected with the hoist way in the vertical direction.

15. The method for installing an elevator of claim 14,
wherein at least one of the first module and the second module can be introduced into the hoist way by the operation of a crane, and
wherein the operation of the crane includes an operation of hoisting and lifting the at least one module, an operation of aligning the at least one module with an opening of the hoist way in the vertical direction, an operation of hoisting and lowering the at least one module within the hoist way, and an operation of fixing and removing the at least one module from the hoist way.

16. The method for installing an elevator of claim 12, wherein the second module includes:
a ceiling that prevents damage from fallen objects;
a guide part that guides the fallen objects; and
a discharge hole that guides the fallen objects to a platform.

17. The method for installing an elevator of claim 12,
wherein at least one of the first module and the second module provides a frame having a predetermined cross-section, and
wherein the frame includes a horizontal bar, a vertical bar, and a reinforcing bar for supporting the horizontal bar.

18. A building provided by the method of claim 1.

19. An elevator provided by the method of claim 12.
